(19) United States
(12) Patent Application Publication
(10) Pub. No.: US 2002/0169723 A1
(43) Pub. Date: Nov. 14, 2002

(54) System and method of knowledge management

(76) Inventor: Hui-Chuan Lin, Taipei (TW)

Correspondence Address: BIRCH STEWART KOLASCH & BIRCH, PO BOX 747, FALLS CHURCH, VA, 22040-0747, US

(21) Appl. No.: 10/140,870

(22) Filed: May 9, 2002

(30) Foreign Application Priority Data
May 11, 2001 (TW) 90111220

(51) Int. Cl. G06F 17/60

(52) U.S. Cl. 705/51

(57) ABSTRACT

A system and method for knowledge management is provided. It integrates information provided by different users into useful knowledge for an enterprise. The knowledge can be transferred via a network to the users who need it. It saves time for knowledge dissemination. The information is stored in a storage location through a “data mirror”, so as to save storage space and prevent data duplication.

### BACKGROUND OF THE INVENTION

1. Field of the Invention

The invention generally relates to a system and method for managing information, and more particularly relates to a process for transforming information into knowledge and systematically and efficiently integrating and transferring information through a network for the purpose of knowledge management.

2. Related Art

The blooming application of internet communication has totally changed the manner of competition for enterprises. Knowledge application has become a competitive weapon in this new era, playing an essential role for enterprise development. For the continued development of enterprise, an organization capable of self-learning is a goal to be pursued. To create a competitive advantage, the main points of a self-learning organization include good knowledge management. Knowledge management of enterprises includes management software for interior groups, an enterprise information portal for access to the outside world, and a search engine for interior and exterior information. The enterprise has to preserve and utilize her knowledge assets regarding information of markets, products, technologies and organizations, which enable the business to generate profits and add value. In the past, employees that left an enterprise also took knowledge away with them. A newcomer has to take a long time to obtain the required knowledge.

Now, knowledge management transforms knowledge assets of enterprises into formatted information so that the knowledge assets are organized and preserved. With effective knowledge management, the knowledge assets and the processes that act upon the assets can be well developed, preserved, utilized and shared. This prevents the enterprise from repeated mistakes and leads to success. Interior knowledge management, enterprise information portals, technical documentation development and search engines are parts of knowledge management that provide information with the right content to the right people. The engineering of knowledge management is not a simple task for an enterprise. It generally requires the efforts of many vendors. For example, a group management process is necessary for interior knowledge interchange, an enterprise information portal is needed for links with exterior suppliers, vendors or customers, and search engines have to be developed for handling and providing structured or non-structured documents to users of different levels.

The process for establishing knowledge in an enterprise starts from identifying and searching critical information and know-how in the enterprise, studying, learning and establishing new processes of information management, and finally storing the knowledge in a reservoir accessible to users. This process is rather complicated. Therefore, there is a need for expediting the knowledge process.

There are further problems in the conventional process of knowledge flow:

It takes much time to transfer knowledge;

It is difficult to manage information revision;

It wastes many resources to backup memory, hard disk and hardware of personal computers;

It wastes much time in knowledge searches (unaware of where the information resides );

Duplicated data wastes memory space;

It wastes much time to organize a document (such as by recording a copy that is only useful for a time);

It is hard to decide whether or not to delete a document. (Though a document is quickly out of date, it is not easy to get information for document deletion).

Web-based knowledge management systems will be mainstream in the future market. An enterprise can manage her interior information through the network. It also accommodates wireless communication in that the employees or customers can retrieve or provide information at any time and any place through a browser or other portable device.

### SUMMARY OF THE INVENTION

The object of the invention is therefore to provide a system and method for executing knowledge management. It especially aims at a self-learning organization, in which disjointed information can be organized into useful knowledge and shared to users. It provides high efficiency for information transfer, reduces knowledge maintenance costs, and provides good interaction among employers, employees and customers. The knowledge management method according to the invention includes the following steps: the system defines privilege of a first administrator for a knowledge base; the first administrator authorizes a second administrator to establish the knowledge base; the second administrator establishes a knowledge base at a suitable reservoir; the system then allows a user to register and use the knowledge base; and finally provides access and inquiry of information in the knowledge base.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a systematic block diagram of a knowledge management system according to the invention; and

FIG. 2 is a flowchart showing the operational process of a central knowledge management system in an embodiment of the invention.

### DETAILED DESCRIPTION OF THE INVENTION

The invention provides a system and method for executing knowledge management. It especially aims at a self-learning organization, in which disjointed information is organized into useful knowledge and shared with users. A web-based enterprise information portal (EIP) is provided for user to access information of the enterprise through the internet or an intranet. The activities of the enterprise, or even virtual libraries, are accessible to users. They can obtain the information of the enterprise, share information and experience the virtual libraries. Thus, everyone can obtain valuable knowledge at any place or time according to their needs.

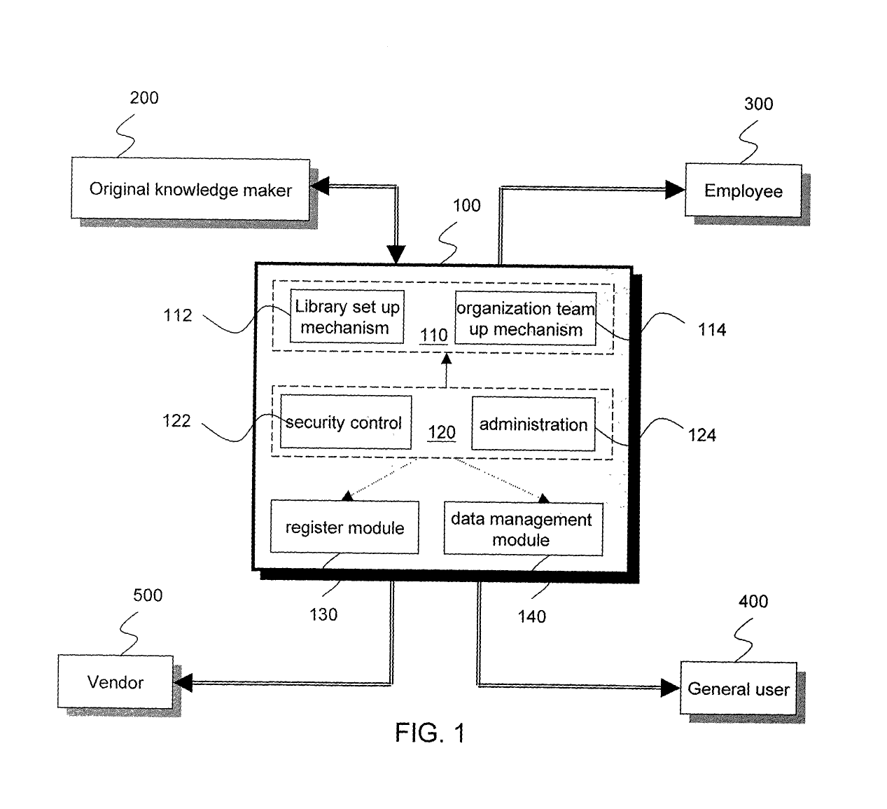

The invention will be described via a preferred embodiment that integrates information coming from different sources and provides required information to users, so as to achieve the purpose of knowledge management. FIG. 1 is a systematic block diagram of a knowledge management system according to the invention. The knowledge management system includes the following components: a central knowledge management system 100, connecting with an original knowledge maker 200, an employee 300, a general user 400 and a vendor 500. The original knowledge maker 200 can be an employee 300, a general user 400 or a vendor 500. The central knowledge management system 100 includes a knowledge base 110, a monitor base 120, a register 130 and a data management module 140. The knowledge base 110 further includes a library set-up mechanism 112 and an organization team-up mechanism 114, which will be described as follows.

The first function of the library set-up mechanism 112 is to set-up different virtual libraries, such as company libraries, department libraries, project libraries, personal libraries or topic libraries according to different companies, different departments, different projects, different employees or different topics. In the libraries, an administrator is in charge of designing the contents of the libraries and handling the data uploaded from users. The central knowledge management system 100 will mandate that employees must establish their own personal libraries as a reference for performance evaluation. The topic libraries can be freely established by employees who wish to do so. When topic libraries are established or discontinued, the central knowledge management system 100 will inform the users.

The second function of the library set-up mechanism 112 is to provide different kinds of knowledge content to different users according to characteristics of the virtual libraries. For example, a virtual library of the human resources department can provide information to newcomers about establishing personal libraries or other instructive courses. A virtual library of the marketing department can provide information to employees or other business partners about products, market information or other relevant topics.

The third function of the library set-up mechanism 112 is to facilitate information utilization. The central knowledge management system 100 manages these virtual libraries so that users can easily search and use them.

The first function of the organization team-up mechanism 114 is to organize the human resources of the organization based on different companies, different departments and different projects so that a small project team, a medium department team or a large company team can be integrated. Therefore, the enterprise can be efficiently reorganized when there are new hires or resignations/terminations, departments merged or divided, or a task force to be assigned.

The second function of the organization team-up mechanism 114 is to allocate employees to the virtual libraries. The central knowledge management system 100 allocates employees of different organizations or different work groups organized by the organization team-up mechanism 114 to their relative virtual libraries set-up by the library set-up mechanism 112, so as to facilitate knowledge dissemination.

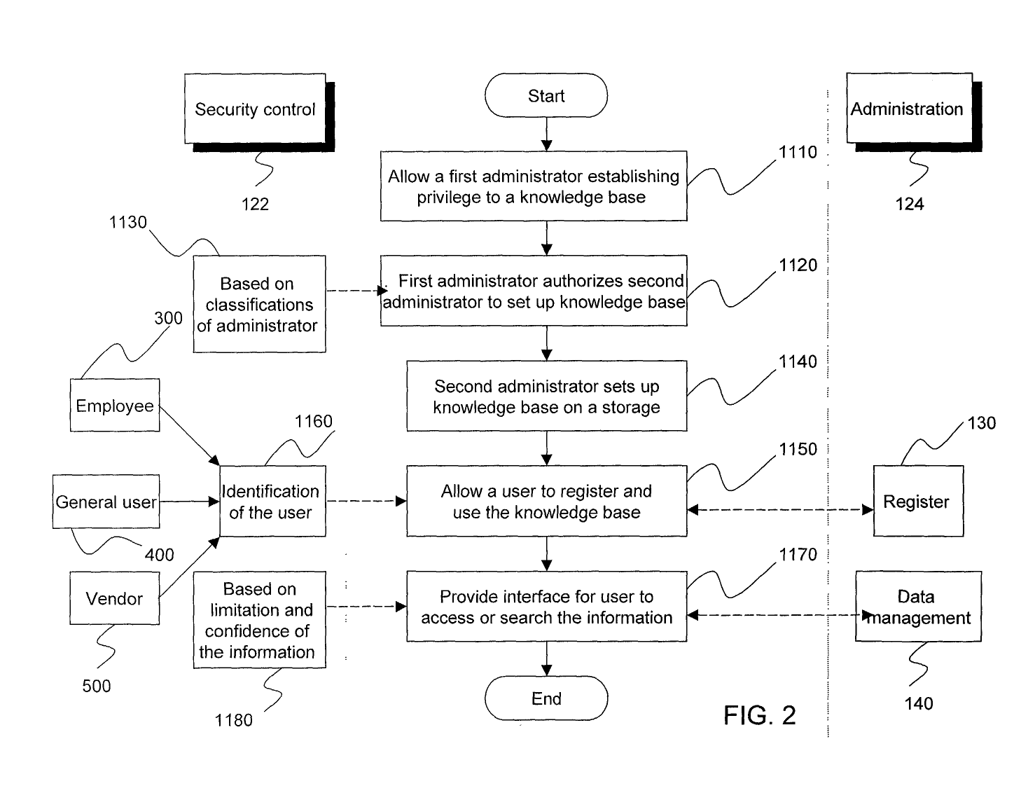

As described above, the knowledge base 110 includes a library set-up mechanism 112 and an organization team-up mechanism 114. The data of the two mechanisms are stored in a specific storage location via a “data mirror”. The storage location is a storage medium. When the administrator transfers data to a virtual library or organization, the central knowledge management system 100 will call up a data code for fetching data stored in the storage medium so as to prevent duplicated data in the medium. Meanwhile, when a user inputs duplicated data into a virtual library or organization, the central knowledge management system 100 checks whether the data have already been stored in the storage medium, and initiates a security control mechanism 122, which will be described later with FIG. 2, for privilege identification.

The monitor base 120 includes the mechanisms of security control 122 and administration 124, which will be described below.

The first function of the security control mechanism 122 is to establish two firewalls for an external virtual library. A first firewall is placed between the central knowledge management system 100 and the virtual library. A second firewall is placed between the virtual library and an external user. When an internal user, such as an employee 300 of the enterprise, enters an external virtual library from the central knowledge management system 100, the firewall will not be initiated. But a user entering the central knowledge management system 100 from the external virtual library must pass the first firewall. An external user, such as a general user 400 or a vendor 500, entering the central knowledge management system 100 or the external virtual library must pass the second firewall.

The second function of the security control mechanism 122 is to control the register module 130 and the data management module 140 of the central knowledge management system 100 when the central knowledge management system 100 is operating. The purpose is to identify, review and authorize a user's privileges by identifying the user, the administrator and the content of the data. This will be described in detail later with FIG. 2.

The major function of the administration mechanism 124 is to monitor and register the data being processed. After a virtual library or an organization is set-up, the central knowledge management system 100 calls the administration mechanism 124 to monitor any data being processed, and registers the data process for an authorized administrator to review. This process will be described later with FIG. 2.

As described above, the monitor base 120 includes the mechanisms of security control 122 and administration 124. The activation of these two mechanisms is triggered by the central knowledge management system 100. When a user makes an inquiry, modification or deletion to the knowledge base, the monitor base 120 will generate a message asking the security control mechanism 122 and the administration mechanism 124 to monitor the user's actions.

The major function of the register 130 is to allow an internal user (such as an employee 300, a general user 400 or a vendor 500) or an external user to register his or her personal information and request access to multiple libraries (such as department libraries, personal libraries or project libraries). The user can input and modify his or her basic information through the register 130, and reach the virtual libraries after passing through a security control mechanism 122 check.

The first function of the data management module 140 is to provide a search engine. Information integrated by the central knowledge management system 100 can be obtained by users through keyword searches. The results are provided to the users via intranet or internet networks.

The second function of the data management module 140 is to manage the lifetime of information. The information stored in the knowledge base 110 is registered respectively with a specific lifetime. When information is stored for a long time, the data management module 140 informs the security control mechanism 122 and requests authorization for deletion. The lifetime is registered in the central knowledge management system 100. For example, a unit of information is registered with a lifetime of ten years. Then in the first five years, the information is accessible through the local sever. The security control mechanism 122 authorizes revision through the data management module 140 for revision control of the information. In the last five years, the data management module 140 informs the security control mechanism 122 to allow the information to be transferred to a low-cost storage space, such as a compact disc, for public use without further security control. After ten years, the data management module 140 deletes the information.

The invention applies the concepts of knowledge management to the network. It utilizes information technology to assist and share knowledge in an enterprise so as to accommodate the current versatile environment of knowledge competition. Information technology helps to establish, share and search knowledge, or even solve problems. It integrates and specifies kinds of information in an enterprise and transforms them into useful knowledge, helping the decision-maker find possible solutions and make good decisions.

FIG. 2 is a flowchart showing the operational process of a central knowledge management system 100 in an embodiment of the invention. It illustrates the authorization and privilege flow of an administrator, and the correlation among mechanisms or modules of the central knowledge management system 100. The flow is described below.

First, the central knowledge management system 100 is turned on. Then, the central knowledge management system 100 initiates the security control 122 and administration mechanisms 124 for monitoring. The central knowledge management system 100 then allows a first administrator to establish privilege to a knowledge base (step 1110). The first administrator can be the chief knowledge officer (CKO) of the enterprise or the chief executive officer (CEO) who has the highest privilege to the knowledge base. The first administrator authorizes a second administrator to set up the knowledge base (step 1120). The privilege of the second administrator is set-up through the security control mechanism 122 based on the classifications of the administrator (step 1130). For example, the administrator is classified by the hierarchy of the organization (such as chief of a branch company, department manager, project leader or employee) or by tasks (such as administration, finance, R&D, etc.).

Then, the second administrator sets up the knowledge base in a storage location (step 1140). The storage location is a storage medium capable of storing data without unnecessary duplication. The knowledge base (virtual library or organization) being set up allows a user to register in order to utilize it (step 1150). During registration, the security control mechanism 122 monitors the identification of the user (step 1160) and checks his or her privilege. The user can be classified as an employee 300, a general user 400 or a vendor 500. Each specific kind of user is allowed to enter the system from a specific portal site. The administration mechanism 124 also initiates the register 130 (as shown in FIG. 1) to provide a plurality of registration forms for the user to register in several virtual libraries in the knowledge base 110. The security control mechanism 122 informs the user through the register 130 whether he or she successfully registered, and stores the registration result into the administration mechanism 124. The registration result includes the user's name, the organization to which the user belongs, the virtual libraries accessible and the maximum privilege the security control mechanism 122 allows. The maximum privilege corresponds to the limitation of information that the user can obtain.

As described above, when a user inputs data or information to a virtual library or organization, the central knowledge management system 100 first checks whether the same data already exists in the storage medium. If it exists, the security control mechanism 122 will be initiated to check the user's privilege. Only a higher privilege user has the right to modify or replace the original file. The system provides an interface for the user to access or search the information stored in the knowledge base 110 (step 1170). The security control mechanism 122 then checks whether the user is privileged to use the information according to the limitation rating and level of confidentiality of the information (step 1180). The administration mechanism 124 also calls the data management module 140 to monitor the status of the information stored in the specific location, and to record the history of processes for the first administrator to review.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A knowledge management system comprising a central knowledge management system for integrating information and providing information to a user, said central knowledge management system comprises:
a knowledge base, for providing a storage space for storing information, storing information input from an original knowledge maker to said storage space and generating a storage message;
a monitor base, for monitoring the activity of said central knowledge management system, and generating a monitoring message corresponding to the operation of said original knowledge maker;
a register, for processing registration of a user, and providing registration forms based on said monitoring message of the monitor base; and
a data management module, for managing the information stored in said storage space, and integrating the information of said knowledge base according to the monitoring message of said monitor base.

2. A knowledge management system according to claim 1 wherein original knowledge maker comprises an external user and an internal user.

3. A knowledge management system according to claim 2 wherein said external user comprises a general user and a vendor; said internal user comprises an employee.

4. A knowledge management system according to claim 1 wherein said knowledge base comprises a library set up mechanism and an organization team up mechanism.

5. A knowledge management system according to claim 4 wherein said library set up mechanism provides the user with different virtual libraries according to different entities.

6. A knowledge management system according to claim 4 wherein said library set up mechanism provides different users with different knowledge contents based on a hierarchy relationship.

7. A knowledge management system according to claim 5 wherein said virtual libraries are chosen from a group comprising company libraries, department libraries, project libraries, personal libraries and topic libraries.

8. A knowledge management system according to claim 4 wherein said organization team up mechanism provides the user with different organizations according to different entities.

9. A knowledge management system according to claim 1 wherein information of said knowledge base is stored in a specific storage location through a manner of “data mirror”.

10. A knowledge management system according to claim 1 wherein said storage message of said knowledge base is a data code for preventing storage of duplicated same information.

11. A knowledge management system according to claim 9 wherein said specific storage location is a storage medium.

12. A knowledge management system according to claim 1 wherein said monitor base comprises a security control and an administration.

13. A knowledge management system according to claim 12 wherein said security control comprises two firewalls for protecting the central knowledge management system.

14. A knowledge management system according to claim 12 wherein said security control monitors and controls said register and said data management module of the central knowledge management system.

15. A knowledge management system according to claim 12 wherein said administration monitors any data being processed, and fully register the data process after the knowledge base being set up.

16. A knowledge management system according to claim 1 wherein said register provides interface for said original knowledge maker to register a plurality of virtual libraries.

17. A knowledge management system according to claim 1 wherein said data management module provides a search engine for inquiry on said central knowledge management system.

18. A knowledge management system according to claim 1 wherein said data management module manages a lifetime of information, which is set up in said central knowledge management system.

19. A method, based on a network, for managing knowledge through a central knowledge management system and finishing works of different levels, the method comprises steps of:
a) allowing a first administrator to establishing privilege to a knowledge base;
b) allowing said first administrator authorizing a second administrator to set up the knowledge base;
c) allowing said second administrator to set up a knowledge base on a storage location;
d) allowing a user to register and use said knowledge base; and
e) allowing the user to access and search the information stored in said knowledge base.

20. A method for managing knowledge according to claim 19 wherein said privilege of a knowledge base established by said first administrator is checked by said central knowledge management system.

21. A method for managing knowledge according to claim 19 wherein said first administrator has a highest privilege to modify information of said knowledge base.

22. A method for managing knowledge according to claim 19 wherein said privilege of the second administrator authorized by said first administrator is set up through a security control based on classifications of administrator.

23. A method for managing knowledge according to claim 19 wherein said privilege of the second administrator is set up according to hierarchy of organization and task analysis.

24. A method for managing knowledge according to claim 19 wherein said step of allowing said second administrator to set up a knowledge base further comprises steps of:
a) storing data in a specific storage location through a manner of “data mirror”; and
b) allowing user to fetch data stored in said storage location through a data code.

25. A method for managing knowledge according to claim 19 wherein said step of allowing a user to register and use said knowledge base further comprises steps of:
a) providing a registration form for the user to sign in;
b) checking the user's privilege for the information through a security control; and
c) registering the registration result in an administration mechanism.

26. A method for managing knowledge according to claim 25 wherein said security control checks the user's privilege according to user identification chosen from a group comprising employee, general user and vendor.

27. A method for managing knowledge according to claim 25 wherein said registration result comprises user name, the organization the user belongs to, the virtual libraries accessible and the maximum privilege the security control allowed.

28. A method for managing knowledge according to claim 19 wherein said step of allowing the user to access and search information comprises steps of:
a) setting data sharing privilege and confidential rating according to information contents by a data management module and an administration mechanism; and
b) controlling data access from said storage location by said data management module and said administration mechanism.
